(19) United States
(12) Patent Application Publication
(10) Pub. No.: US 2022/0414612 A1
(43) Pub. Date: Dec. 29, 2022

(54) SYSTEM FOR MANAGING A VEHICLE FLEET

(71) Applicant: Continental Teves AG & Co. oHG, Frankfurt am Main (DE)

(72) Inventors: Boris Lorenz, Frankfurt am Main (DE); Sebastian Zier, Frankfurt am Main (DE); Hans Schroth, Frankfurt am Main (DE); Stefan Heinrich, Frankfurt am Main (DE)

(21) Appl. No.: 17/771,980

(22) PCT Filed: Oct. 30, 2020
(86) PCT No.: PCT/EP2020/080504

§ 371 Date: Apr. 26, 2022

(30) Foreign Application Priority Data
Oct. 30, 2019 (DE) 10 2019 216 774.8

(51) Int. Cl. G06Q 10/00

(52) U.S. Cl. CPC G06Q 10/20

(57) ABSTRACT

A system for managing a vehicle fleet of at least partially autonomously driving vehicles in a vehicle depot, including: a capture unit to capture the respective position of the vehicles in a vehicle group of the fleet arranged in the depot. The vehicles in the group each have a service plan which instructs the respective vehicle to carry out vehicle service in the depot, a communication interface receives a signal from at least one further vehicle in the fleet which drives into the depot, and a control unit assigns a further service plan to the further vehicle based on the captured respective position of the vehicles in the group in the depot and based on the received signal from the further vehicle. The communication interface transmits the further service plan to the further vehicle. The further service plan instructs the further vehicle to carry out vehicle service in the depot.

### CROSS REFERENCE TO RELATED APPLICATIONS

This application is the U.S. National Phase Application of PCT International Application No. PCT/EP2020/080504, filed Oct. 30, 2020, which claims priority to German Patent Application No. 10 2019 216 774.8, filed Oct. 30, 2019, the contents of such applications being incorporated by reference herein.

### FIELD OF THE INVENTION

The present invention relates to a system for managing a vehicle fleet, in particular a system for managing a vehicle fleet of at least partially autonomously driving vehicles in a vehicle depot.

### BACKGROUND OF THE INVENTION

The switch to at least partially autonomously driving vehicles presents the operators of vehicle fleets and corresponding mobility service providers with challenges in managing corresponding vehicle fleets. The corresponding vehicles in the vehicle fleet not only have to be made available to the user in a timely manner, but continuous maintenance, cleaning and technical inspection of the vehicles must also be carried out in a vehicle depot.

In conventional vehicle depots, a manageable number of non-autonomously driving vehicles are usually manually maintained, cleaned and checked for technical faults by people with machine support. In a vehicle fleet of at least partially autonomously driving vehicles with possibly hundreds or even more than a thousand vehicles, manual service of the respective vehicles can however, under certain circumstances, lead to undesirable delays and losses in quality when carrying out the vehicle service and can increase the operating costs.

### SUMMARY OF THE INVENTION

An of the present invention is an efficient concept for a system for managing a vehicle fleet of at least partially autonomously driving vehicles in a vehicle depot, in which the performance of the system can be increased by a high degree of automation in order to reduce the time required and the operating costs for servicing the vehicles while at the same time guaranteeing a high service quality. Another object is also to ensure efficient self-calibration of sensors of the vehicles in the vehicle fleet in the vehicle depot.

According to an aspect of the invention, this object is achieved by the features of the independent patent claims. The dependent claims, the description and the figures relate to advantageous embodiments of the present invention.

According to a first aspect, the invention relates to a system for managing a vehicle fleet of at least partially autonomously driving vehicles in a vehicle depot, comprising a capture unit which is designed to capture the respective position of the vehicles in a vehicle group of the vehicle fleet arranged in the vehicle depot, wherein the vehicles in the vehicle group each have a service plan which instructs the respective vehicle to carry out a vehicle service in the vehicle depot, a communication interface which is designed to receive a signal from at least one further vehicle in the vehicle fleet which drives into the vehicle depot, and a control unit which is designed to assign a further service plan to the further vehicle based on the captured respective position of the vehicles in the vehicle group in the vehicle depot and based on the received signal from the further vehicle, wherein the communication interface is designed to transmit the further service plan to the further vehicle, wherein the further service plan instructs the further vehicle to carry out a vehicle service in the vehicle depot.

In this case, the service plan can in particular be flexibly adapted to the service requirement and to the utilization of the capacities of service stations in the vehicle depot. In particular, the system ensures that the vehicle-specific service plans are iteratively checked for optimal conditions, in particular with regard to the operating costs, time and/or availability, and initiates adaptation of the respective service plans, if necessary.

The vehicle fleet here includes in particular a large number of, in particular hundreds or more than a thousand, at least partially autonomously driving vehicles which are arranged inside the vehicle depot for the respective vehicle service and outside the vehicle depot for the respective driving assignment.

The vehicle group of the vehicle fleet here includes in particular the vehicles in the vehicle fleet that are arranged in the vehicle depot at a given point in time in order to carry out a vehicle service in each case. The at least one further vehicle in the vehicle fleet here includes in particular a single vehicle or a plurality of vehicles which, after the respective driving assignment, drive into the vehicle depot from outside the vehicle depot. In this case, the communication interface of the system is designed, in particular, to receive the signal from the further vehicle before the further vehicle drives into the vehicle depot when the vehicle is still outside the vehicle depot, and/or the communication interface of the system is designed, in particular, to receive the signal from the further vehicle after the further vehicle has driven into the vehicle depot when the vehicle is already inside the vehicle depot.

The at least partially autonomously driving vehicles in the vehicle fleet can be, for example, motor vehicles, electric vehicles and/or hybrid vehicles.

At least partially autonomously driving vehicles include partially autonomously driving vehicles in which the driving assistance systems assume significant tasks in guiding the respective vehicle, so that permanent monitoring by the driver is no longer required. At least partially autonomously driving vehicles also here include fully autonomously driving vehicles in which a driver is no longer required to guide the respective vehicle. In particular, the at least partially autonomously driving vehicles can move automatically, i.e. without the intervention of the driver. In particular, vehicles that move automatically can also be remotely controlled, in particular automatically by the system and/or manually by an operator.

The vehicle depot here includes in particular at least one location, which in particular has enclosed and/or free-standing areas, at which the vehicles in the vehicle fleet are located in order to carry out the respective vehicle service, the vehicles moving in the vehicle depot in particular automatically, in particular in a remotely controlled manner. In particular, the vehicle depot comprises a single location at which the service stations that are present in particular are arranged. Alternatively, the vehicle depot can also include a plurality of locations that are spatially spaced apart from one another, with the service stations that are present in particular being distributed over the plurality of locations.

The service plan and/or further service plan here include(s) in particular an instruction to the respective vehicle to carry out at least one vehicle service in the vehicle depot. The service plan includes in particular the number of vehicle services, the order in which the respective vehicle services are carried out, the location of the respective vehicle services in the vehicle depot, the type of the respective vehicle services and/or the duration of the respective vehicle services.

The basic idea of an aspect of the present invention is that, when carrying out vehicle services for a large number of at least partially autonomously driving vehicles in a vehicle fleet in a vehicle depot, a high degree of automation can be achieved, which ensures a high level of efficiency and quality in carrying out the respective vehicle services. In addition, optimization of the space requirement can be ensured and time can be saved through fast throughput times. Thus, a high availability of vehicles for the mobility service provider can be ensured.

In particular, based on the available information relating to the positions of the vehicles in the vehicle depot, the system can in this case continuously update the respective service plans of the vehicles in order to ensure that the vehicles are efficiently distributed, e.g. to unoccupied service stations, in the vehicle depot. Due to the ability of the at least partially autonomously driving vehicles to move in particular automatically in the vehicle depot, the respective service plan can be implemented particularly efficiently by the respective vehicle in order to thereby carry out a highly effective dynamic distribution of the vehicles in the vehicle depot. Due to the high degree of automation, the number of manual work steps carried out by human workers can be advantageously reduced in this case when carrying out the respective vehicle services in the vehicle depot.

According to one embodiment of the present invention, the vehicle depot has a plurality of service stations, at each of which a vehicle service is carried out, wherein the service plan instructs the respective vehicle in the vehicle group and the further service plan instructs the at least one further vehicle to carry out a vehicle service at a service station of the plurality of service stations.

This achieves the advantage of ensuring that a multiplicity of vehicle services of the vehicles are efficiently carried out at the service stations. In this case, the respective service stations of the plurality of service stations are designed in particular to carry out different vehicle services on the respective vehicles which are arranged at the respective service station. In particular, the service stations are designed to carry out the respective vehicle service automatically, in particular without manual intervention of a human worker.

According to one embodiment of the present invention, the capture unit is designed to capture the occupancy of the service stations by vehicles in the vehicle fleet, wherein the control unit is designed to update the service plan of at least one vehicle in the vehicle group and/or the further service plan of the at least one further vehicle depending on the occupancy of the service stations, and wherein the communication interface is designed to transmit the updated service plan to the at least one vehicle in the vehicle group and/or to transmit the updated further service plan to the further vehicle.

This achieves the advantage that the system continuously ensures that the individual service stations are optimally utilized by vehicles and that updating the service plans makes it possible to dynamically redistribute vehicles to the respective service stations.

According to one embodiment of the present invention, the control unit is designed to update the service plan of at least one vehicle in the vehicle group arranged in the vehicle depot based on the further service plan of the further vehicle, wherein the communication interface is designed to transmit the updated service plan to the at least one vehicle in the vehicle group.

This achieves the advantage that the service plans of the vehicles can be updated in both directions, i.e. by updating the further service plan of the further vehicle when driving into the vehicle depot, and/or by updating at least one service plan of the vehicles in the vehicle group which are already located in the vehicle depot. When the further vehicle drives into the vehicle depot, the system can redistribute the vehicles in the vehicle group in the vehicle depot, particularly if the further service plan has a high priority, in order to give the further vehicle priority in the respective vehicle service.

According to one embodiment of the present invention, the plurality of service stations comprise at least two of the following service stations: a service station for registering the further vehicle when driving into the vehicle depot, a service station for deregistering a vehicle in the vehicle fleet when driving out of the vehicle depot, a service station for cleaning the exterior of a vehicle in the vehicle fleet, a service station for cleaning the interior of a vehicle in the vehicle fleet, a service station for checking the operating state of the tires of a vehicle in the vehicle fleet, a service station for visually inspecting a vehicle in the vehicle fleet, a service station for checking the operating state of the electrical lines of a vehicle in the vehicle fleet, a service station for the self-calibration of sensors of a vehicle in the vehicle fleet, a service station for replacing a vehicle battery of a vehicle in the vehicle fleet, a service station for electrically charging a vehicle battery of a vehicle in the vehicle fleet, a service station for parking a vehicle in the vehicle fleet, a service station for carrying out a test drive of a vehicle in the vehicle fleet, a service station for checking the driving characteristics of a vehicle in the vehicle fleet, and/or a service station for checking an acoustic profile of a vehicle in the vehicle fleet.

This achieves the advantage that the individual service stations can carry out a multiplicity of different vehicle services on the vehicles in the vehicle fleet.

According to one embodiment of the present invention, the vehicle depot, in particular a service station for the self-calibration of sensors of a vehicle in the vehicle fleet, has at least one reference object which can be captured by sensors of a vehicle in the vehicle fleet, wherein the system, in particular the control unit and/or a control test stand of the service station for the self-calibration of sensors of a vehicle in the vehicle fleet, is designed to receive the data generated on the basis of the capture of the reference object by the sensors of the vehicle and to compare the received data with reference data in order to carry out the self-calibration of the sensors of the vehicle.

This achieves the advantage that effective self-calibration of the sensors of the vehicle is ensured, so that it is possible to ensure that errors are excluded during operation in the at least partially autonomously driving vehicles in the vehicle fleet. Thus, during operation of the at least partially autonomously driving vehicles, technically flawless roadworthiness of the respective vehicle can be guaranteed and thus clearance for participation in road traffic can be ensured.

In particular, the system, in particular the control unit and/or the service station for the self-calibration of sensors of a vehicle in the vehicle fleet, has a position capture element, in particular at least one camera, which is designed to capture the position of the vehicle while the reference object is being captured by the sensors of the vehicle in order to generate the reference data based on the position of the vehicle.

In particular, the reference data can include data that were generated based on the capture of the reference object by further sensors of the vehicle. Thus, the self-calibration of the sensors of the vehicle can be achieved by comparing different data sets that have been recorded by different sensors of the vehicle.

According to one embodiment of the present invention, the control unit is designed to assign the service plans to the respective vehicles in the vehicle group and/or to assign the further service plan to the at least one further vehicle based on at least one of the following methods: numerical solution methods, in particular Monte Carlo simulations, and/or recursively self-optimized artificial intelligence. This ensures that the respective service plans are assigned in an advantageous manner.

According to one embodiment of the present invention, the signal from the further vehicle comprises at least one of the following signals: results of a self-test of the further vehicle at component and/or system level, camera data from the vehicle interior of the further vehicle, audio data of the further vehicle, log data of a tachograph of the further vehicle, data relating to an operating state of a vehicle battery of the further vehicle, and/or data relating to a period of use and/or a collective load and/or the systems and/or the individual components of the further vehicle.

This achieves the advantage that the signals transmitted to the control unit by the further vehicle enable the further service plan to be created effectively. In particular, the signal also includes self-diagnosis and usage data, in particular collective loads, of a plurality of, in particular all, built-in vehicle systems and components that have their own sensors and/or self-analysis capability, including in particular safety-relevant assemblies for operating the vehicle.

According to one embodiment of the present invention, the system has at least one sensor unit which is designed to capture an operating state of the further vehicle, wherein the control unit is designed to update the further service plan of the further vehicle based on the captured operating state of the further vehicle, and wherein the communication interface is designed to transmit the updated further service plan to the further vehicle.

This achieves the advantage that the sensor unit, in particular a camera, can effectively capture the operating state, in particular optically, in particular when the further vehicle drives into the vehicle depot, and can take it into account together with the signal transmitted by the further vehicle and together with the captured position of the vehicles in the vehicle group in order to create an updated further service plan.

According to one embodiment of the present invention, the sensor unit comprises at least one camera which is designed to optically capture the operating state of the further vehicle, and/or the sensor unit comprises an acoustic sensor which is designed to acoustically capture the operating state of the further vehicle, and/or the sensor unit comprises a radar sensor which is designed to capture the operating state of the further vehicle by means of radar radiation.

This achieves the advantage that the specific sensor units can ensure that the operating state of the further vehicle is effectively checked and assessed, in particular when driving into the vehicle depot.

According to a second aspect, the present invention relates to a method for managing a vehicle fleet of at least partially autonomously driving vehicles in a vehicle depot, comprising: capturing the respective position of the vehicles in a vehicle group of the vehicle fleet arranged in the vehicle depot by means of a capture unit, wherein the vehicles in the vehicle group each have a service plan which instructs the respective vehicle to carry out a vehicle service in the vehicle depot, receiving a signal from at least one further vehicle in the vehicle fleet, which drives into the vehicle depot, by means of a communication interface, assigning a further service plan to the further vehicle based on the respective captured position of the vehicles in the vehicle group in the vehicle depot and based on the received signal from the further vehicle by means of a control unit, transmitting the further service plan to the further vehicle by means of the communication interface, wherein the further service plan instructs the further vehicle to carry out a vehicle service in the vehicle depot.

### BRIEF DESCRIPTION OF THE DRAWINGS

Further exemplary embodiments are explained in more detail with reference to the accompanying figures, in which:

FIG. 1 shows a schematic illustration of a system for managing a vehicle fleet in a vehicle depot according to one embodiment of the invention,

FIG. 2 shows a schematic illustration of a system for managing a vehicle fleet in a vehicle depot according to one embodiment of the invention,

FIG. 3 shows a schematic illustration of areas of a vehicle that are captured by vehicle sensors, and

FIG. 4 shows a schematic illustration of a service station for the self-calibration of sensors of a vehicle according to one embodiment.

### DETAILED DESCRIPTION OF PREFERRED EMBODIMENTS OF THE INVENTION

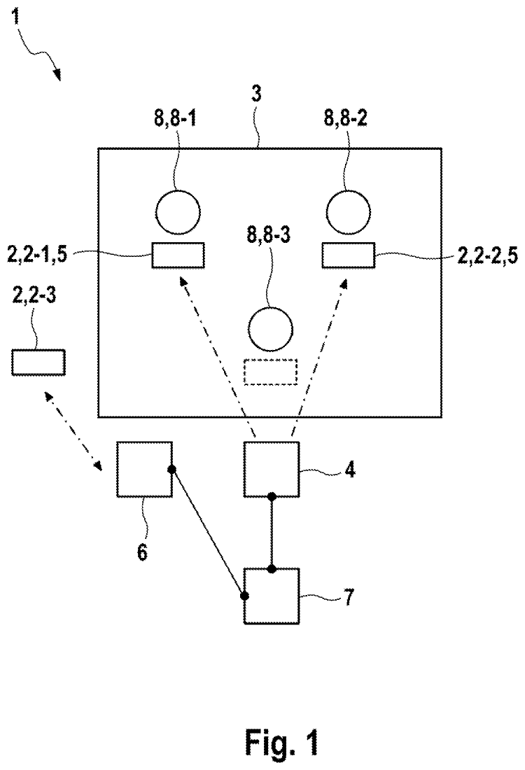

FIG. 1 shows a schematic illustration of a system 1 for managing a vehicle fleet of at least partially autonomously driving vehicles 2 in a vehicle depot 3. In particular, the vehicle depot 3 can comprise a single location, so that the service stations are united under one roof, or the vehicle depot 3 can comprise a plurality of locations which are spatially spaced apart from one another and to which the service stations are distributed.

The switch to at least partially autonomously driving vehicles 2 will lead to a major change for the operators of vehicle fleets and for mobility service providers, who will take on the responsibility for managing the respective vehicle fleet. This includes not only the provision of the vehicles 2 and the planning for their use, but also the maintenance, cleaning and technical inspection of the vehicles 2, which are usually carried out in a vehicle depot 3.

The vehicles 2 are inspected and maintained in a vehicle depot 3, with the interior and exterior of the vehicle 2 being cleaned, the vehicle 2 being inspected for damage, the state being assessed and, if necessary, the vehicle 2 being refilled with operating materials, in particular.

At least partially autonomously driving vehicles 2 include partially autonomously driving vehicles 2 in which the driving assistance systems assume significant tasks in guiding the respective vehicle 2, so that permanent monitoring by the driver is no longer required. At least partially autonomously driving vehicles 2 also here include fully autonomously driving vehicles 2 in which a driver is no longer required to guide the respective vehicle 2. In particular, vehicles 2 that move automatically can also be remotely controlled, in particular automatically by the system 1 and/or manually by an operator.

In fleets of at least partially autonomously driving vehicles 2, fleet sizes of more than a thousand vehicles 2 may be reached, for which an efficient maintenance and service system must be provided and it must also be ensured that the individual vehicles 2 in the vehicle fleet flexibly drive into and out of the vehicle depot 3.

Efficiently controlled use of the vehicle fleet at high utilization reduces the available time window for maintaining the fleet, particularly to night-time hours when there is a reduced need for mobility and the vehicles 2 in the vehicle fleet can advantageously be maintained.

In this case, it is particularly advantageous to carry out the service, especially during the night-time hours, possibly independently of human assistance and without manual control of the vehicles 2 in the vehicle fleet, but rather by independently moving the at least partially autonomously driving vehicles 2 in the vehicle depot 3.

Due to the high degree of automation achieved in this way, a high throughput of the vehicles 2 can be ensured around the clock with a consistently high quality of the maintenance work.

The system 1 illustrated in FIG. 1 comprises a capture unit 4 which is designed to capture the respective position of the vehicles 2 in a vehicle group 5 of the vehicle fleet arranged in the vehicle depot 3.

In the embodiment illustrated in FIG. 1, the vehicle group 5 arranged in the vehicle depot 3 comprises only a first vehicle 2-1 and a second vehicle 2-2. However, the vehicle group can in particular include several hundred or even more than a thousand vehicles 2.

In this case, the vehicles 2 in the vehicle group 5 each have a service plan which instructs the respective vehicle 2 to carry out a vehicle service in the vehicle depot 3.

The system 1 illustrated in FIG. 1 also includes a communication interface 6 which is designed to receive a signal from at least one further vehicle 2-3 in the vehicle fleet which drives into the vehicle depot 3. In this case, the at least one further vehicle 2-3 can transmit the signal to the communication interface 6 while driving into the vehicle depot 3 or even before driving into the vehicle depot 3.

Here, the signal received by the communication interface 6 includes in particular at least one of the following signals: results of a self-test of the further vehicle 2-3 at component and/or system level, camera data from the vehicle interior of the further vehicle 2-3, audio data of the further vehicle 2-3, log data of a tachograph of the further vehicle 2-3, data relating to an operating state of a vehicle battery of the further vehicle 2-3, and/or data relating to a period of use and/or a collective load and/or the systems and/or the individual components of the further vehicle 2-3.

The system 1 illustrated in FIG. 1 also includes a control unit 7 which is designed to assign a further service plan to the further vehicle 2-3 based on the captured positions of the vehicles 2 in the vehicle group 5 in the vehicle depot 3 and based on the received signal from the further vehicle 2-3. The communication interface 6 is designed to transmit the further service plan assigned to the further vehicle 2-3 to the further vehicle 2-3.

Here, the vehicle depot 3 includes in particular a plurality of service stations 8, at each of which a vehicle service is carried out. The service plan transmitted to the further vehicle 2-3 instructs the further vehicle 2-3 in particular to carry out a vehicle service at a service station 8 of the plurality of service stations 8.

The capture unit 4 is designed in particular to capture the occupancy of the service stations 8 by vehicles 2 in the vehicle fleet, wherein the control unit 7 is designed to update the service plan of the further vehicle 2-3 depending on the occupancy of the service stations 8.

In particular, the service plan instructs the further vehicle 2-3 to carry out a vehicle service at a service station 8 not occupied by a vehicle 2 in the vehicle group 5, in particular the third service station 8-3 of the plurality of service stations 8.

In particular, the service plan can instruct the further vehicle 2-3 to move itself to the selected service station 8 in order to carry out the vehicle service.

The plurality of service stations 8 comprise in particular at least two of the following service stations 8: a service station 8 for registering the further vehicle 2-3 when driving into the vehicle depot 3, a service station 8 for deregistering a vehicle 2 in the vehicle fleet when driving out of the vehicle depot 3, a service station 8 for cleaning the exterior of a vehicle 2 in the vehicle fleet, a service station 8 for cleaning the interior of a vehicle 2 in the vehicle fleet, a service station 8 for checking the operating state of the tires of a vehicle 2 in the vehicle fleet, a service station 8 for visually inspecting a vehicle 2 in the vehicle fleet, a service station 8 for checking the operating state of the electrical lines of a vehicle 2 in the vehicle fleet, a service station 8 for the self-calibration of sensors of a vehicle 2 in the vehicle fleet, a service station 8 for replacing a vehicle battery of a vehicle 2 in the vehicle fleet, a service station 8 for electrically charging a vehicle battery of a vehicle 2 in the vehicle fleet, a service station 8 for parking a vehicle 2 in the vehicle fleet, a service station 8 for carrying out a test drive of a vehicle 2 in the vehicle fleet, a service station 8 for checking the driving characteristics of a vehicle 2 in the vehicle fleet, and/or a service station 8 for checking an acoustic profile of a vehicle 2 in the vehicle fleet.

In particular, the control unit 7 is designed to update the service plan of at least one vehicle 2 in the vehicle group 5 arranged in the vehicle depot 3 based on the further service plan of the further vehicle 2-3. In this case, the communication interface 6 is designed to transmit the updated service plan to the at least one vehicle 2 in the vehicle group 5.

Thus, in particular, all vehicles 2 in the vehicle depot 3, including the at least one further vehicle 2-3 and the vehicles 2 in the vehicle group 5, each have a service plan.

The control unit 7 calculates the service plan and/or the further service plan in particular on the basis of numerical solution methods, in particular Monte Carlo simulations, or by means of recursively self-optimized artificial intelligence.

The system 1 can in particular have at least one sensor unit, in particular a camera, which is designed to capture an operating state of the further vehicle 2-3 driving into the vehicle depot 3, wherein the control unit 7 is designed to update the service plan of the further vehicle 2-3 based on the captured operating state of the further vehicle 2-3. The communication interface 6 is designed in particular to transmit the updated service plan to the further vehicle 2-3.

Thus, in addition to the vehicle data of the further vehicle 2-3 which are captured by the communication interface 6, the control unit 7 also has the position of each vehicle 2 in the vehicle group 5 within the vehicle depot 3, as well as the occupancy of the service stations 8 by vehicles 2, and possibly also the operating state of the further vehicle 2-3 captured by the sensor unit.

As a result, the control unit 7 of the system 1 receives an exact state description of all vehicles 2 in the vehicle depot 3, which can be optimized with regard to a multiplicity of state variables.

Based on the information, an individually coordinated further service plan is determined for the further vehicle 2-3 and is transmitted to the further vehicle 2-3. In this case, the service plan of the further vehicle 2-3 and the service plans of the vehicles 2 in the vehicle group 5 are in particular continuously compared depending on newly arriving further vehicles 2-3, checked with regard to their optimization specifications and adjusted if necessary. Replanning can therefore take place at any time in order to optimize the overall process if necessary.

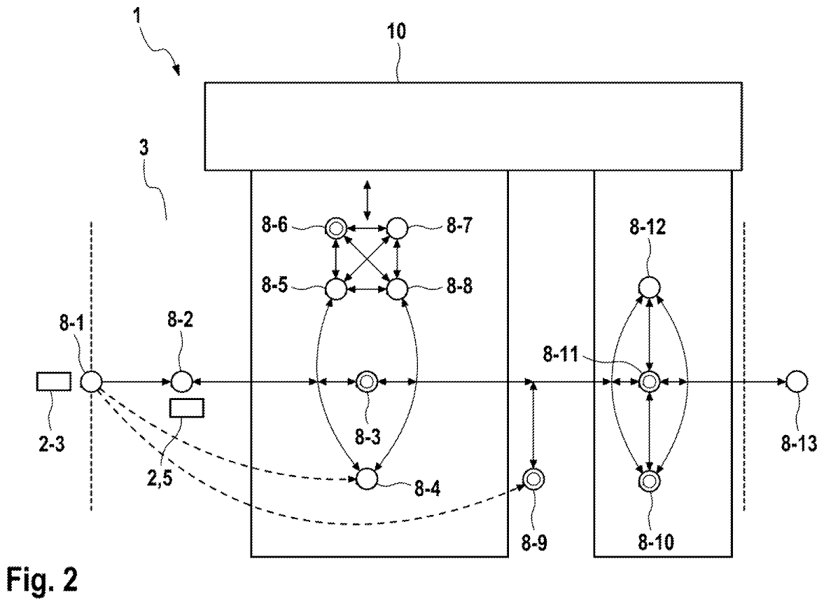

FIG. 2 shows a schematic illustration of a system 1 for managing a vehicle fleet of at least partially autonomously driving vehicles 2 in a vehicle depot 3 according to a further embodiment. The capture unit 4, the communication interface 6 and the control unit 7 of the system 1 are not illustrated in FIG. 2.

The first service station 8-1 includes a service station 8 for registering the further vehicle 2-3 when driving into the vehicle depot 3. The second service station 8-2 includes a service station 8 for cleaning the exterior of a vehicle 2. As illustrated in FIG. 2, the second service station 8-2 is occupied by a vehicle 2 in the vehicle group 5.

The third service station 8-3 includes a service station 8 for cleaning the interior of a vehicle 2. The fourth service station 8-4 includes a service station 8 for replacing a vehicle battery of a vehicle 2. The fifth service station 8-5 includes a service station 8 for checking the operating state of the tires of a vehicle 2. The sixth service station 8-6 includes a service station 8 for visually inspecting a vehicle 2. The seventh service station 8-7 includes a service station 8 for checking the operating state of the electrical lines of a vehicle 2. The eighth service station 8-8 includes a service station 8 for the self-calibration of sensors of a vehicle 2.

The ninth service station 8-9 includes a service station 8 for parking a vehicle 2 and for electrically charging a vehicle battery of the vehicle 2. The tenth service station 8-10 includes a service station 8 for checking the driving characteristics of a vehicle 2. The eleventh service station 8-11 includes a service station 8 for checking an acoustic profile of a vehicle 2. The twelfth service station 8-12 includes a service station 8 for deregistering a vehicle 2 when driving out of the vehicle depot 3. The thirteenth service station 8-13 includes a service station 8 for carrying out a test drive of a vehicle 2.

As can be seen in FIG. 2, the transitions between the service stations 8 are in particular only possible along the schematically illustrated arrows, either unidirectionally in one direction or bidirectionally in both directions.

The multiplicity of possible arrangements of the individual vehicles 2 in the vehicle fleet at the respective service stations 8 results in a large number of options for how an individual vehicle 2 can pass through the respective service stations 8.

Reference sign 10 denotes a repair service station 10 to which a vehicle 2 is supplied if it fails a specific test at one of the service stations 8.

For further details, reference is made to the statements relating to FIG. 1.

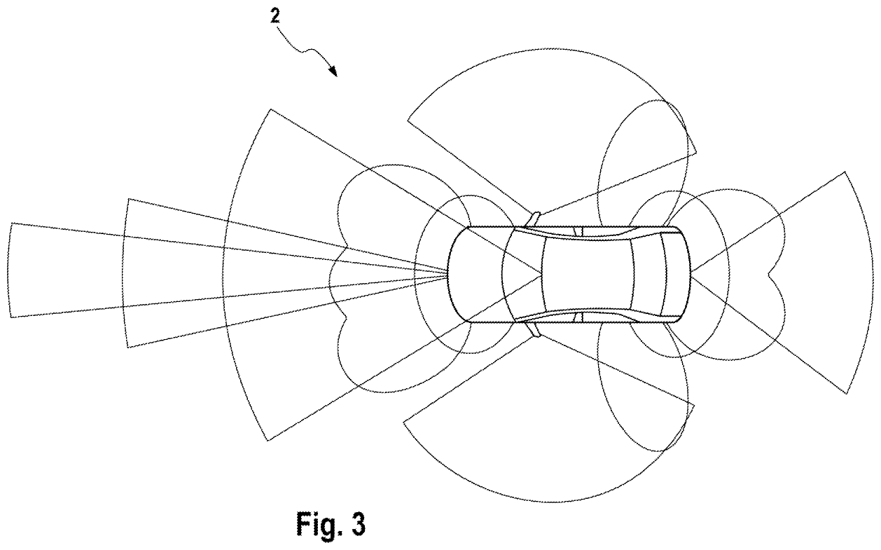

FIG. 3 shows a schematic illustration of areas of a vehicle 2 that are captured by vehicle sensors. The areas captured by the sensors of the vehicle 2 overlap at least partially in this case, with the result that an object can be captured by more than one sensor in the corresponding overlapping areas. Corresponding sensors of the vehicle 2 can in particular include ultrasonic sensors for the short range and/or wheel sensors for the long range.

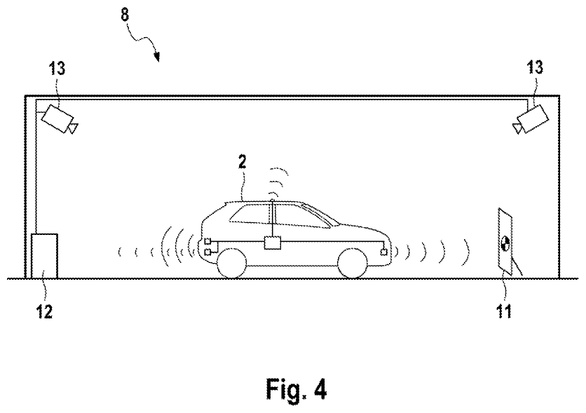

FIG. 4 shows a schematic illustration of a service station 8 for the self-calibration of sensors of a vehicle 2 according to one embodiment. In the case of at least partially autonomously driving vehicles 2, it is crucial that the sensors of the vehicle 2 are fully functional and do not supply incorrect results, since intervention by a human driver cannot be guaranteed in all situations.

The service station 8 illustrated only schematically in FIG. 4 has a reference object 11 which can be captured by the sensors of the vehicle 2. A control test stand 12 of the service station 8 is designed to compare the data captured on the basis of the capture of the reference object 11 by the sensors of the vehicle 2 with reference data in order to calibrate the sensors of the vehicle 2. Here, the reference data of the control test stand 12 can be captured in particular by a position capture unit 13, in particular a camera.

The reference object 11 can in particular include patterns or be designed as a calibration panel or include three-dimensional shapes or three-dimensional reference objects 11.

For this purpose, it must be ensured that the corresponding data can be transmitted between the vehicle 2 and the control test stand 12.

The self-calibration includes not only the comparison of the vehicle positions, measured on the one hand by the sensors of the vehicle 2 and on the other hand by the position capture unit 13, but also in particular the comparison of individual measured values from different sensors of the vehicle 2 with one another. This comparison can be carried out in particular by the control unit 7 of the system 1, which for this purpose receives and processes all measurement data from all the sensors of the vehicle 2, or can alternatively be carried out by an evaluation unit in the vehicle 2.

The reference object 11 includes, in particular, a plurality of reference objects 11 which are arranged in particular in the service station 8 around the vehicle 2 such that a plurality of sensors can measure the same reference object 11 during transit. For this purpose, the reference objects 11 are positioned in such a way that they can be captured in overlapping areas by two or more sensors of the vehicle 2, as is illustrated in FIG. 3, for example.

The data from the sensors of the vehicle 2 can be validated against one another and checked for plausibility by being compared with one another. As the vehicle 2 drives through, the same reference objects 11 are scanned one after the other by a plurality of sensors. This results in an advantage over a static measurement in which only individual pairs of sensors that have overlapping measurement ranges can be validated against one another. The dynamic measurement allows the data from all sensors that have recognized the same reference object 11 to be checked.

The self-calibration of sensors of the vehicle 2 illustrated in FIG. 4 enables a fully automatic, quick and reliable check of the sensors of a vehicle 2, which represents a highly relevant service step within the framework of a service check of a vehicle 2.

In particular, the self-calibration of sensors of the vehicle 2 illustrated in FIG. 4 can also be carried out outside of a service station 8, for example at a location between two service stations 8, with the result that the self-calibration of the sensors of the vehicle 2 can be carried out, for example, while the vehicle 2 is being transferred between two service stations 8.

### LIST OF REFERENCE SIGNS

### 1 System

### 2 Vehicle

2-1 First vehicle
2-2 Second vehicle
2-3 At least one further vehicle
3 Vehicle depot
4 Capture unit
5 Vehicle group
6 Communication interface
7 Control unit
8 Service station
8-n n-th service station
10 Repair service station
11 Reference object
12 Control test stand
13 Position capture unit

1. A system for managing a vehicle fleet of at least partially autonomously driving vehicles in a vehicle depot, comprising:
a capture unit which is designed to capture the respective position of the vehicles in a vehicle group of the vehicle fleet arranged in the vehicle depot, wherein the vehicles in the vehicle group each have a service plan which instructs the respective vehicle to carry out a vehicle service in the vehicle depot,
a communication interface which is designed to receive a signal from at least one further vehicle in the vehicle fleet which drives into the vehicle depot, and
a control unit which is designed to assign a further service plan to the further vehicle based on the captured respective position of the vehicles in the vehicle group in the vehicle depot and based on the received signal from the further vehicle,
wherein the communication interface is designed to transmit the further service plan to the further vehicle, wherein the further service plan instructs the further vehicle to carry out a vehicle service in the vehicle depot.

2. The system as claimed in claim 1, wherein the vehicle depot has a plurality of service stations, at each of which a vehicle service is carried out, wherein the service plan instructs the respective vehicle in the vehicle group and the further service plan instructs the at least one further vehicle to carry out a vehicle service at a service station of the plurality of service stations.

3. The system as claimed in claim 2, wherein the capture unit is designed to capture the occupancy of the service stations by vehicles in the vehicle fleet, and wherein the control unit is designed to update the service plan of at least one vehicle in the vehicle group and/or the further service plan of the at least one further vehicle depending on the occupancy of the service stations, and wherein the communication interface is designed to transmit the updated service plan to the at least one vehicle in the vehicle group and/or to transmit the updated further service plan to the further vehicle.

4. The system as claimed in claim 1, wherein the control unit is designed to update the service plan of at least one vehicle in the vehicle group arranged in the vehicle depot based on the further service plan of the further vehicle, wherein the communication interface is designed to transmit the updated service plan to the at least one vehicle in the vehicle group.

5. The system as claimed in claim 2, wherein the plurality of service stations comprise at least two of the following service stations:
a service station for registering the further vehicle when driving into the vehicle depot,
a service station for deregistering a vehicle in the vehicle fleet when driving out of the vehicle depot,
a service station for cleaning the exterior of a vehicle in the vehicle fleet,
a service station for cleaning the interior of a vehicle in the vehicle fleet,
a service station for checking the operating state of the tires of a vehicle in the vehicle fleet,
a service station for visually inspecting a vehicle in the vehicle fleet,
a service station for checking the operating state of the electrical lines of a vehicle in the vehicle fleet,
a service station for the self-calibration of sensors of a vehicle in the vehicle fleet,
a service station for replacing a vehicle battery of a vehicle in the vehicle fleet,
a service station for electrically charging a vehicle battery of a vehicle in the vehicle fleet,
a service station for parking a vehicle in the vehicle fleet, a service station for carrying out a test drive of a vehicle in the vehicle fleet,
a service station for checking the driving characteristics of a vehicle in the vehicle fleet, and/or
a service station for checking an acoustic profile of a vehicle in the vehicle fleet.

6. The system as claimed in claim 1, wherein the vehicle depot is a service station for the self-calibration of sensors of a vehicle in the vehicle fleet, and has at least one reference object which can be captured by sensors of a vehicle in the vehicle fleet, wherein the control unit and/or a control test stand of the service station for the self-calibration of sensors of a vehicle in the vehicle fleet, is designed to receive the data generated on the basis of the capture of the reference object by the sensors of the vehicle and to compare the received data with reference data in order to carry out the self-calibration of the sensors of the vehicle.

7. The system as claimed in claim 1, wherein the control unit is designed to assign the service plans to the respective vehicles in the vehicle group and/or to assign the further service plan to the at least one further vehicle based on at least one of the following methods: numerical solution methods, in particular Monte Carlo simulations, and/or recursively self-optimized artificial intelligence.

8. The system as claimed in claim 1, wherein the signal from the further vehicle comprises at least one of the following signals:
results of a self-test of the further vehicle at component and/or system level,
camera data from the vehicle interior of the further vehicle,
audio data of the further vehicle,
log data of a tachograph of the further vehicle,
data relating to an operating state of a vehicle battery of the further vehicle, and/or
data relating to a period of use and/or a collective load and/or the systems and/or the individual components of the further vehicle.

9. The system as claimed in claim 1, wherein the system has at least one sensor unit which is designed to capture an operating state of the further vehicle, wherein the control unit is designed to update the further service plan of the further vehicle based on the captured operating state of the further vehicle, and wherein the communication interface is designed to transmit the updated further service plan to the further vehicle.

10. A method for managing a vehicle fleet of at least partially autonomously driving vehicles in a vehicle depot, the method comprising:
capturing the respective position of the vehicles in a vehicle group of the vehicle fleet arranged in the vehicle depot by a capture unit, wherein the vehicles in the vehicle group each have a service plan which instructs the respective vehicle to carry out a vehicle service in the vehicle depot,
receiving a signal from at least one further vehicle in the vehicle fleet, which drives into the vehicle depot, by a communication interface,
assigning a further service plan to the further vehicle based on the captured respective position of the vehicles in the vehicle group in the vehicle depot and based on the received signal from the further vehicle by a control unit, and
transmitting the further service plan to the further vehicle by the communication interface, wherein the further service plan instructs the further vehicle to carry out a vehicle service in the vehicle depot.
